(19) United States
(12) Patent Application Publication
(10) Pub. No.: US 2004/0078831 A1
(43) Pub. Date: Apr. 22, 2004

(54) System for receiving and storing an integrated data stream representative of a plurality of broadcasted television programs scheduled for simultaneous presentation on a corresponding plurality of assigned broadcast channels enabling viewers to subsequently extract selected programs from stored data stream for viewing

(75) Inventors: Timothy Alan Dietz, Austin, TX (US); Walid Kobrosly, Round Rock, TX (US); Nadeem Malik, Austin, TX (US)

Correspondence Address: Mark E. McBurney, International Business Machines Corporation, Intellectual Property Law Dept., Internal Zip 4054, 11400 Burnet Road, Austin, TX, 78758, US

(73) Assignee: International Business Machines Corporation, Armonk, NY

(21) Appl. No.: 10/273,616

(22) Filed: Oct. 17, 2002

(51) Int. Cl. H04N 7/173; H04N 7/16

(52) U.S. Cl. 725/142; 725/134

(57) ABSTRACT

A method and program wherein the whole received integrated data stream representative of the entire set of scheduled television programs for the time period on a corresponding set of designated frequency channels is provided by a service provider, received and stored within a user's personal video recorder in its integrated and compressed form. As a result, for at least a period of time until the storage capacity of the disk drive apparatus on which the integrated data stream is stored, and the data stream has to be dumped on a first-in/first-out basis, the viewer is enabled to extract any stored television program from the integrated data for viewing or for conventional rerecording for future viewing.

### TECHNICAL FIELD

The present invention relates to Personal Video Recorders (PVRs) and, particularly, to enhanced functions for such PVRs.

### BACKGROUND OF RELATED ART

The past decade has been marked by a technological revolution driven by the convergence of the data processing industry with the consumer electronics industry. An area where this relationship has been advantageous is that of digital video recording. This has resulted in the emergence of a set top box based upon the PVR. A description of the PVR and like digital video recorders and their increasing consumer functions as computer controlled “engines” in television set top boxes may be found in: IEEE Spectrum periodical, (IEEE Inc.), New York. N.Y., July 2002, at pp. 26-31. The PVR has many advantages, particularly ease of use to the users in the advance scheduling of television programs to be subsequently sequentially recorded.

The present invention relates to a unique function of PVRs with respect to data streams of television programming provided by television service providers such as cable, e.g. cablevision or satellite television service providers. In order to better appreciate this invention, the background of such cable and satellite services needs to be considered. As the demand for television programming rapidly increased, frequency channels that the Government made available for the presentation of programming by respective television stations also rapidly increased. This led to television service providers that obtained and consolidated the programs transmitted by the respective television stations to be presented to viewers at Government designated frequency channels. The original television stations would transmit at their assigned frequencies either by direct line of sight, cable or through satellites. The television service providers then received the respective program channel signals and consolidated all the data in such transmissions into an integrated data stream representative of an extensive set of television programs being presented on corresponding channels into a unitary data stream that was then compressed and transmitted to the television service provider's subscribers either via satellite or by cable. This integrated data stream was encrypted to protect the provider's revenues. The viewer could then receive this integrated data stream and extract any “live” or real-time television program through his conventional television frequency channel tuner. The provider system would extract the appropriate television program data directly from the real-time satellite of cable service provider integrated data stream. The extracted program data would be decrypted and decompressed and the television program would be displayed on a real-time basis on the television set display.

Where the user wished to record a particular television program for future viewing, it would be extracted at its scheduled viewing period from the integrated data stream in the same manner as described, decrypted, decompressed and recorded on video tape. Even with the recent commercialization of digital recording on disk drives (DVD), only single individual programs on their respective channels could still be recorded on a real-time basis by first extracting, decrypting and decompressing. With cable provided integrated data streams, the viewer was enabled to record one program on its respective channel while he was viewing another program channel. With a satellite fed integrated data stream, even this simultaneous viewing and recording on two different program channels was not possible unless the system had two different receivers.

In addition, in order to record television programs for future viewing, the viewer had to make a decision to record in advance of, or at the start of, a scheduled television program on a specified frequency channel. The viewer could not decide in retrospect, i.e. after the program was scheduled for presentation, that he wished to have the program recorded.

### SUMMARY OF THE PRESENT INVENTION

The present invention expands the function of PVRs to moderate and relieve the above problems by providing a system, method and program wherein the whole received integrated data stream representative of the entire set of scheduled television programs for the time period on a corresponding set of designated frequency channels is received and stored within the PVR in its integrated and compressed form. As a result, for at least a period of time until the storage capacity of the disk drive apparatus on which the integrated data stream is stored, and the data stream has to be dumped on a first-in/first-out basis, the viewer is enabled to extract any stored television program from the integrated data for viewing or for conventional rerecording for future viewing.

Accordingly, the present invention involves a computer controlled interactive television system comprising receiving apparatus for receiving an integrated data stream representative of said plurality of television programs presentable on said corresponding plurality of television channels; apparatus for storing said integrated data; a television display; apparatus enabling a user to request the presentation of one of said plurality of stored television programs on said television display; apparatus responsive to said user request for extracting the data representative of said requested television program from said stored integrated data; and apparatus for presenting said requested television program on said television display. The storage apparatus is desirably disk drive storage apparatus of increased capacity as will be hereinafter described in greater detail. The system is applicable to both satellite transmitted and cable transmitted received integrated data streams.

It should be noted that the invention is also applicable to satellite systems including at least one satellite transponder for transmitting the integrated data representative of a subset of the plurality of television programs presentable on a corresponding subset of the plurality of television channels.

The preferred hardware embodiment involves a television set top box housing comprising the receiving apparatus for receiving the integrated data stream representative of said plurality of television programs presentable on said corresponding plurality of television channels, the apparatus for storing said integrated data, the apparatus enabling a user to request the presentation of one of said plurality of stored television programs on said television display, the apparatus responsive to said user request for extracting the data representative of said requested television program, and the apparatus for presenting said requested television program on said television display.

As will be described hereinafter in greater detail, the user is enabled to predetermine the television program content of said integrated data stream, i.e. the user is permitted to chose from several groups or sets of integrated programs, e.g. sports, arts and music, science channel programming, etc.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a generalized diagrammatic view of a landscape illustrative of how integrated data streams of data representative of a set of television programs are gathered, organized and distributed by both cable and satellite transmission television service providers;

FIG. 2 is a generalized view of how the system of the present invention is organized around a Personal Video Recorder;

FIG. 3 is a flowchart describing how the integrated data stream system of the present invention provides for the storage of such integrated data streams and for the extraction and display of user selected stored television programs; and

FIG. 4 is a flowchart of an illustrative run of a process set up in FIG. 3.

### DETAILED DESCRIPTION OF THE PREFERRED EMBODIMENT

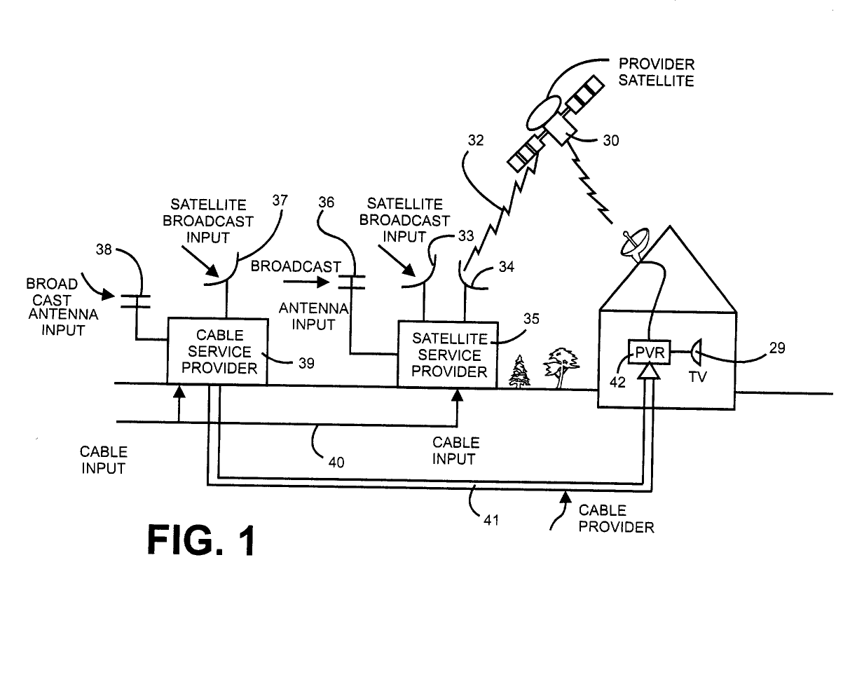

Referring to FIG. 1, there is shown a generalized landscape diagram to illustrate the current standard provision of integrated unitary data streams representative of an extensive plurality of television programs presentable on a corresponding plurality of assigned frequency television channels licensed to television stations for the presentation, i.e. broadcast of television programs. Accordingly, a typical cable, e.g. cablevision service provider 39, gathers in television program data signals from various broadcast signals, e.g. satellite broadcast input 37, cable broadcast input 40 and traditional line of sight input 38. Similarly, a typical satellite TV service provider 35 gathers in television program data signals from similar broadcast signals, e.g. satellite broadcast input 33, cable broadcast input 40 and traditional line of sight input 36. The cablevison television service provider 39 then consolidates all of these inputs into a continuous integrated data stream signal representative of all of the television programming respectively scheduled for each assigned frequency channel for each time period that, at the present state of the art, involves hundreds of channels. At present, this integrated data stream may be segmented into several integrated data stream segments, each representative of a particular type or body of programming available on a corresponding set of frequency channels, e.g. a movie film set, a sports set, a family entertainment set, etc. Such integrated data stream segments may be made up of as much as 50 to 100 channel programs scheduled for simultaneous presentation. Irrespective of whether the integrated data stream that the present invention is addressing is made of the programs on all of the channels distributed by the service provider or just a segment of a particular type of programming, the improvements offered by the present invention equally apply.

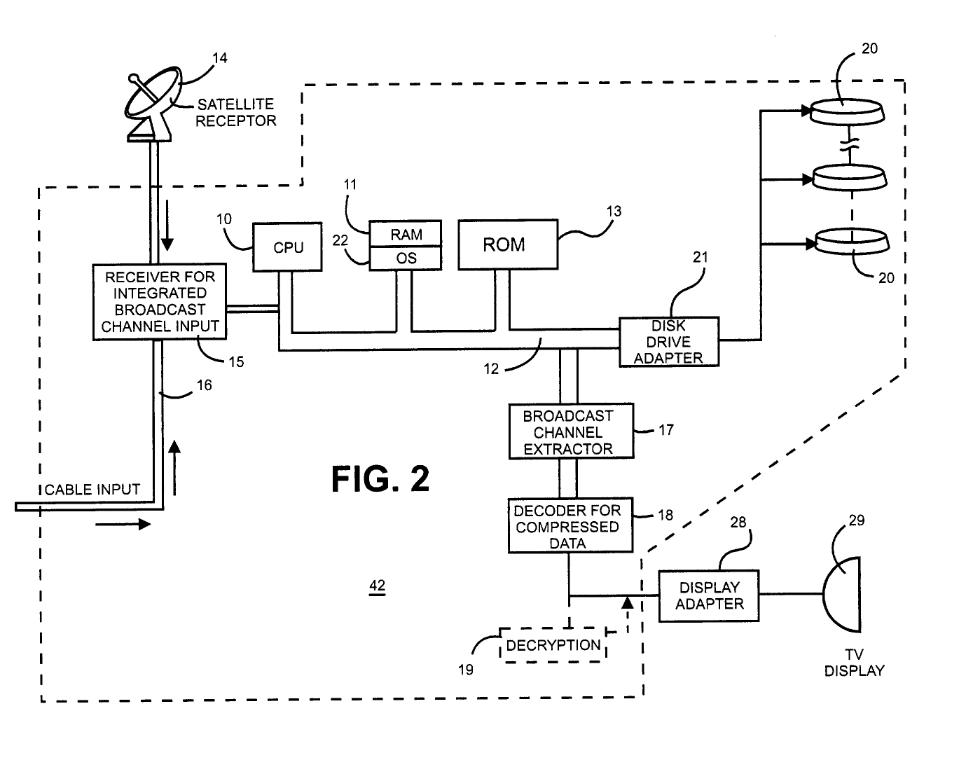

The cable service provider then compresses and encrypts the integrated data stream and distributes via transmission on cable 41 to the home of the subscriber where it is handled, for illustration of the present invention by PVR 42 and presented on TV set 29, as will hereinafter be described in greater detail with respect to FIG. 2. A similarly integrated data stream signal 32 is sent from satellite provider 35 via antenna 34 to a fixed position provider satellite 30 from which it is returned as integrated data stream signal 31 to PVR 42.

Now, with respect to FIG. 2, the operations on the PVR 42 will be described. The apparatus shown may be conveniently housed in a television set top box. Satellite receptor antenna 14 receives the integrated data stream that is applied to a standard receiver for integrated broadcast channel input 15. Similarly, the integrated data stream from cable may be applied through input 16 to receiver 15.

The operations involved in the present invention are controlled by a data processing system under the control of a central processing unit 10, which, in turn, is interconnected to various other components by system bus 12. An operating system 22 that runs on processor 10 provides control and is used to coordinate the functions of the various components of the control system. The OS 22 is stored in Random Access Memory (RAM) 11. The programs for the functions including those of the present invention are permanently stored in Read Only Memory (ROM) 13 and moved into and out of RAM to perform their respective functions. In the normal operation for real-time television program playing, the integrated incoming data stream, under CPU control, is applied to broadcast channel extractor 17 that extracts the data representative of the television program scheduled for the channel that the user has conventionally tuned to on a tuner (not shown) and applies the extracted data to decoder 18 where it is decompressed. Also, since the data is likely to be encrypted to commercially protect the provider, encrypted data is optionally put through conventional decryption means 19 and then applied to a conventional television display adapter 28 to be displayed on the user's television set 29.

There will now be considered the recording of the incoming unitary integrated data stream that is the key to the present invention. It is done through a disk drive system via disk drive adapter 21 on multiple disk drives 20. In the conventional operation of a PVR, only a single television program scheduled for a given channel at a given time would be extracted by extractor 17, decompressed on decoder 18, decrypted and then stored on the single disk drive provided on the PVR. This individual program would be recorded and, thus, stored on the disk drive either in response to either advance scheduling by the user for such a recording or a user request to record a real-time presented television program. The user would have no other options.

In accordance with the present invention, the whole incoming integrated data stream input into receiver 15 is continuously recorded onto the disk drives 20. We have determined that with a conventional 175 channel satellite input, there is a storage requirement of 65 MBytes for storing each second of compressed data in the whole integrated data stream representing the simultaneous programs on the 175 channels. Using current practical disk drive technology, there can be provided four disk drives 20, each with about 80-100 gigabytes. With this capacity, the disk drive system could hold about one hour of an integrated data stream representing the total television programming on the 175 channels. If the user chose an integrated data stream segment or subset representative of only about 80 channels of programs, about two hours of total programming could be recorded.

The advantages of such an improvement are clear. For example, if a viewer turns on his television set and discovers a television program in progress that he wishes to view in its entirety, he could request that the portion of the program already past but recorded as part of the integrated data stream stored on disk drives 20 be extracted, decompressed and decrypted, but then separately stored on the disk drives 20 along with the subsequent portions of the selected program for later viewing. Also, with, let us say, an 80 channel integrated data stream input, the viewer who was not available for “prime-time”, 7:00 through 9:00 PM, could set the PVR system to regularly record for each day the entire integrated data stream for all 80 channels on disk drives 20. Then, later in the day when his time schedule permitted, the user could then review the whole recorded “prime time” programming and select what he wished to view. This would then be extracted from the integrated stored data stream, decompressed, decrypted and displayed on TV 29 through display adapter 28.

It will be understood that the state of the disk drive art at present permits a practical application involving about four coordinated disk drive units providing a total of up to 400 MBytes. However, disk drive capacities continue to increase at a significant rate. It is not hard to envision the continuous recording of whole integrated data streams covering a full day or more of complete programming on service provider feeds of more than 100 channels.

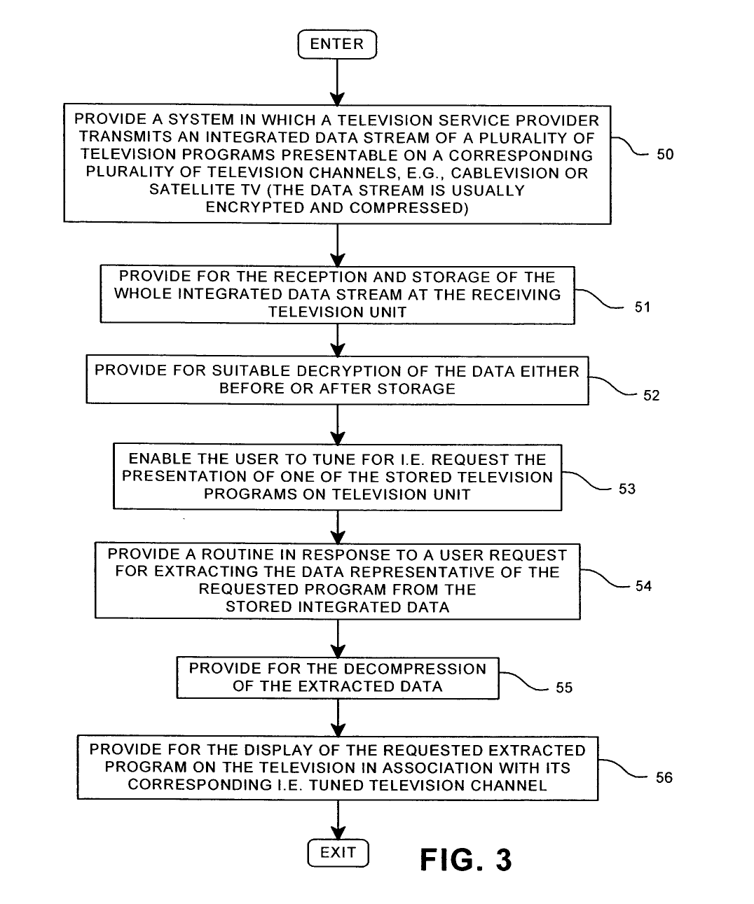

Now, with reference to the programming shown in FIG. 3, there will be described how the system and programs of the present invention are set up. There is provided a basic service provider system in which there is transmitted an integrated data stream of a plurality of television programs presentable on a corresponding plurality of television channels, e.g. cable or satellite TV, step 50. Provision is made for the reception and storage of the whole integrated stream at the receiving television unit, step 51. Decryption is provided for the data stream, preferably after extraction from the stored data, step 52. The user is enabled to tune for, i.e. request the presentation of one of the stored television programs on the television set, step 53. In response to a user request in step 53, a routine is provided for extracting the data representative of the requested program from the stored integrated data, step 54. Provision is made for the decompression of the extracted data, step 55. Provision is made for the display of the requested television program on the television set on its corresponding, i.e. tuned television frequency channel, step 56.

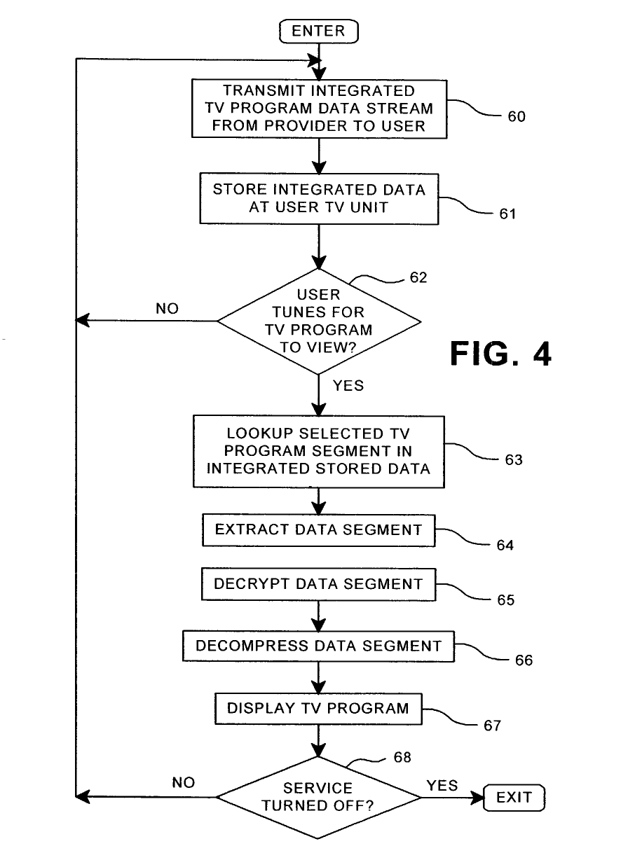

Now, with reference to the flowchart of FIG. 4, a simplified illustrative run of the process set up in FIG. 3 will be described. An integrated TV program data stream from a provider to a user, step 60. The whole integrated data stream is stored in association with the user TV unit, step 61. A determination is made as to whether a user has tuned for a selected TV program to view, step 62. If No, the process is branched back to step 60, where the transmission of the input integrated data stream continues. If Yes, then the selected TV program is looked up within the stored integrated data stream, step 63, and the data for the program is extracted, step 64. The extracted data segment is decrypted, step 65, and decompressed, step 66. It is applied so that the selected TV program may be displayed, step 67. Then a determination may be made as to whether the service provider service has been turned off, step 68. If Yes, the display function is exited. If No, the process is branched back to step 60 where the transmission of the input integrated data stream continues.

Although certain preferred embodiments have been shown and described, it will be understood that many changes and modifications may be made therein without departing from the scope and intent of the appended claims.

What is claimed is:

1. A computer controlled user interactive system for receiving and storing data representative of a plurality of television programs presentable on a corresponding plurality of television channels comprising:
receiving apparatus for receiving an integrated data stream representative of said plurality of television programs presentable on said corresponding plurality of television channels;
apparatus for storing said integrated data;
a television display;
apparatus enabling a user to request the presentation of one of said plurality of stored television programs on said television display;
apparatus responsive to said user request for extracting the data representative of said requested television program from said stored integrated data; and
apparatus for presenting said requested television program on said television display.

2. The system of claim 1 wherein said apparatus for storing said integrated data is disk drive storage apparatus.

3. The system of claim 2 further including cable apparatus for transmitting said integrated data stream to said receiving apparatus.

4. The system of claim 2 further including satellite transmission apparatus for transmitting said integrated data stream to said receiving apparatus.

5. The system of claim 4 further including at least one satellite transponder for transmitting said integrated data representative of a subset of said plurality of television programs presentable on a corresponding subset of said plurality of television channels.

6. The system of claim 1 further including a television set top box housing comprising:
said receiving apparatus for receiving said integrated data stream representative of said plurality of television programs presentable on said corresponding plurality of television channels;
said apparatus for storing said integrated data;
said apparatus enabling a user to request the presentation of one of said plurality of stored television programs on said television display;
said apparatus responsive to said user request for extracting the data representative of said requested television program; and
said apparatus for presenting said requested television program on said television display.

7. The system of claim 1 wherein said integrated data is digital data.

8. The system of claim 1 further including apparatus enabling a user to predetermine the television program content of said integrated data stream.

9. The system of claim 1 wherein said integrated data stream is encrypted, and further including apparatus for decrypting said extracted data.

10. The system of claim 1 wherein said integrated data stream is compressed, and further including apparatus for decoding said compressed data prior to extraction.

11. In computer controlled television reception, a method for receiving and storing data representative of a plurality of television programs presentable on a corresponding plurality of television channels comprising:
receiving an integrated data stream representative of said plurality of television programs presentable on said corresponding plurality of television channels;
storing said integrated data;
enabling a user to request the presentation of one of said plurality of stored television programs on a television display;
extracting the data representative of said requested television program responsive to a user request for said television program; and
presenting said requested television program on said television display.

12. The method of claim 11 wherein said integrated data is stored on disk drive storage.

13. The method of claim 12 further including the step of transmitting said integrated data stream for said television reception via cablevison transmission.

14. The method of claim 12 further including the step of transmitting said integrated data stream for said television reception via satellite transmission.

15. The method of claim 14 further including the step of transmitting an integrated data stream representative of a subset of said plurality of television programs presentable on a corresponding subset of said plurality of television channels via a satellite transponder.

16. The method of claim 11 wherein said integrated data is digital data.

17. The method of claim 11 further including the step of enabling a user to predetermine the television program content of said integrated data stream.

18. The method of claim 11 wherein said integrated data stream is encrypted, and further including the step of decrypting said extracted data.

19. The method of claim 11 wherein said integrated data stream is compressed, and further including the step of decoding said compressed data prior to extraction.

20. A computer program having code recorded on a computer readable medium for controlling the receiving and storing of an integrated data stream representative of a plurality of television programs presentable on a corresponding plurality of television channels in a computer controlled television reception system comprising:
means for receiving said integrated data stream representative of said plurality of television programs presentable on said corresponding plurality of television channels;
means for storing said integrated data;
means enabling a user to request the presentation of one of said plurality of stored television programs on a television display;
means responsive to said user request for extracting the data representative of said requested television program from said stored integrated data; and
means for presenting said requested television program on said television display.

21. The computer program of claim 20 wherein said means for storing said integrated data is a disk drive storage means.

22. The computer program of claim 21 further including cable means for transmitting said integrated data stream to said receiving apparatus.

23. The computer program of claim 21 further including satellite transmission means for transmitting said integrated data stream to said receiving apparatus.

24. The computer program of claim 17 further including at least one satellite transponder for transmitting said integrated data stream representative of a subset of said plurality of television programs presentable on a corresponding subset of said plurality of television channels.

25. The computer program of claim 20 wherein said integrated data is digital data.

26. The computer program of claim 20 further including means for enabling a user to predetermine the television program content of said integrated data stream.

27. The computer program of claim 20 wherein said integrated data stream is encrypted, and further including means for decrypting said extracted data.

28. The computer program of claim 20 wherein said integrated data stream is compressed, and further including means for decoding said compressed data prior to extraction.
